(19) United States
(12) Patent Application Publication
(10) Pub. No.: US 2025/0270853 A1
(43) Pub. Date: Aug. 28, 2025

(54) FENESTRATION UNIT WITH ADJUSTABLE BOLT RECEIVER

(71) Applicant: JELD-WEN, Inc., Charlotte, NC (US)

(72) Inventor: Jacob David Anderson, Redmond, OR (US)

(73) Assignee: JELD-WEN, Inc., Charlotte, NC (US)

(21) Appl. No.: 18/587,309

(22) Filed: Feb. 26, 2024

(51) Int. Cl. E05B 65/08

(52) U.S. Cl. CPC E05B 65/087

(57) ABSTRACT

An adjustable bolt receiver includes a first member and a second member. The first member includes at least one first engagement feature. The second member includes a strike head and an insert projection that projects from the strike head. The insert projection is receivable in a first opening of the first member in a first position along the axis and, alternatively, in a second position along the axis. The second member includes at least one second engagement feature configured to engage with the at least one first engagement feature for retaining the insert projection in the first position and in the second position along the axis. The insert projection at least partly defines a second opening configured to receive a bolt when in the extended position to secure the panel to the panel support.

### TECHNICAL FIELD

The field of this disclosure relates generally to fenestration units and, more particularly, to a fenestration unit with an adjustable bolt receiver.

### BACKGROUND

Fenestration units, such as sliding patio door units, sliding window units, etc. may include a bolt securement system. For example, a panel (e.g., door leaf, window sash, etc.) of the fenestration unit may be supported by a support structure (e.g., frame, sill, foundation, header, etc.), and the bolt securement system may include a bolt that is moveably attached to the panel and a receiver hole in the support structure. The bolt (e.g., a shoot-bolt, flush-bolt, etc.) may be selectively extended outward from the panel and into the receiver hole to secure the panel to the support structure.

However, it can be difficult, time consuming, and costly to ensure proper alignment between the sliding axis of the bolt and the receiving hole. Some bolt securement systems may be undesireably bulky or otherwise visually displeasing. Furthermore, the bolt securement system may be difficult, expensive, and/or time consuming to manufacture. Installation and/or repair of the bolt adjustment system may also be difficult and time consuming. The part count may be relatively high, which may disadvantageously increase complexity and cost.

Accordingly, there is a need for a bolt securement system for a fenestration unit for more convenient and ergonomic alignment of the bolt and receiving member. Furthermore, there is a need for a bolt securement system that is compact and aesthetically pleasing. There is also a need for a bolt securement system that may be manufactured inexpensively, with a relatively low part count, etc. Additional aspects and benefits will be apparent from the following detailed description of example embodiments, which proceeds with reference to the accompanying drawings.

### BRIEF SUMMARY

In an example embodiment, an adjustable bolt receiver for selectively securing a panel of a fenestration unit to a panel support of the fenestration unit is disclosed wherein the fenestration unit has a bolt that is slidably attached to the panel for movement between a retracted position and an extended position relative to the panel for selectively engaging with the panel support. The adjustable bolt receiver includes a first member configured to be fixedly attached to the panel support, and the first member has a first opening defining an axis. The first member includes at least one first engagement feature. Moreover, the adjustable bolt receiver includes a second member that includes a strike head and an insert projection that projects from the strike head. The insert projection is receivable in the first opening in a first position along the axis and, alternatively, in a second position along the axis. The second member includes at least one second engagement feature configured to engage with the at least one first engagement feature for retaining the insert projection in the first position and in the second position along the axis. The insert projection at least partly defines a second opening configured to receive the bolt when in the extended position to secure the panel to the panel support.

Also, in another embodiment, a method of manufacturing an adjustable bolt receiver configured for selectively securing a panel of a fenestration unit to a panel support of the fenestration unit is disclosed, wherein the fenestration unit has a bolt that is slidably attached to the panel for movement between a retracted position and an extended position relative to the panel for selectively engaging with the panel support. The method includes providing a first member configured to be fixedly attached to the panel support, and the first member has a first opening defining an axis. The first member includes at least one first engagement feature. Furthermore, the method includes providing a second member that includes a strike head and an insert projection that projects from the strike head. The second member includes at least one second engagement feature, and the insert projection at least partly defining a second opening configured to receive the bolt when in the extended position to secure the panel to the panel support. The method also includes selecting one of a first position for the insert projection in the first opening along the axis and a second position for the insert projection in the second opening along the axis. Additionally, the method includes inserting the insert projection in the selected one of the first position and the second position. The at least one second engagement feature is configured to engage with the at least one first engagement feature for retaining the insert projection in the first position and, alternatively, in the second position along the axis.

Additionally, in a further embodiment, a fenestration unit is disclosed that includes a panel with a bolt that is slidably attached thereto for movement between a retracted position an extended position relative to the panel. The fenestration unit includes a frame that supports the panel for sliding movement within the frame along an axis, and the frame includes a sill. Moreover, the fenestration unit includes an adjustable bolt receiver that includes a first member configured to be fixedly attached to the sill, and the first member has a first opening that extends along the axis. The first member includes at least one array of ridges and slots. Also, the adjustable bolt receiver includes a second member that includes a strike head and an insert projection that projects from the strike head. The insert projection is receivable in the first opening in a first position along the axis and, alternatively, in a second position along the axis. The second member includes at least one flange that is removably engaged within one of the slots of the array in the first position and in another of the slots of the array in the second position. The insert projection at least partly defines a second opening configured to receive the bolt when in the extended position to secure the panel to the panel support.

### BRIEF DESCRIPTION OF DRAWINGS

The various embodiments will hereinafter be described in conjunction with the following drawing figures, wherein like numerals denote like elements, and wherein:

FIG. 1 is a schematic plan view of a fenestration unit with a bolt securement system according to example embodiments of the present disclosure;

FIG. 2 is a cross-sectional view of the fenestration unit and bolt securement system taken along the line 2-2 of FIG. 1;

FIG. 3 is an exploded perspective view of an adjustable bolt receiver of the bolt securement system of FIG. 2;

FIG. 4 is a plan view of the adjustable bolt receiver of FIG. 3;

FIG. 5 is a plan view of a first member of the adjustable bolt receiver of FIG. 3;

FIG. 6 is a side view of the first member of FIG. 5;

FIG. 7 is a cross-sectional view of the first member taken along the line 7-7 of FIG. 5, wherein the first member is shown in a mold cavity during an exemplary manufacturing method of the adjustable bolt receiver;

FIG. 8 is a bottom view of a second member of the adjustable bolt receiver of FIG. 3; and

FIG. 9 is a cross-sectional view of the second member taken along the line 9-9 of FIG. 8, wherein the second member is shown in a mold cavity during an exemplary manufacturing method of the adjustable bolt receiver.

### DETAILED DESCRIPTION

The following Detailed Description is merely exemplary in nature and is not intended to limit the various embodiments or the application and uses thereof. Furthermore, there is no intention to be bound by any theory presented in the preceding background or the following detailed description.

Generally, embodiments of the present disclosure include a fenestration unit with a bolt securement system. The bolt securement system may include a bolt that may be selectively extended from a panel of the fenestration unit. The bolt securement system may also include an adjustable bolt receiver configured to receive the bolt. The position of the adjustable bolt receiver may be selectively adjusted for conveniently aligning with the sliding axis of the bolt. Methods of manufacturing and assembling the fenestration unit, bolt securement system, and adjustable bolt receiver are also disclosed.

The adjustable bolt receiver may include a first member that may be attached, for example, to the sill of a fenestration frame. The first member may, in some embodiments, be snap-fit into the sill. The adjustable bolt receiver may further include a second member that may be fixedly attached to the first member in one of a plurality of positions.

For example, the second member may include a strike head and an insert projection with an opening that extends through the second member and through the insert projection. The opening may be sized to receive the bolt when extended out from the panel. The insert projection may be inserted into a larger opening defined in the first member in one of a plurality of positions. The first and second members may include complimentary engagement features, such as tapered flanges of one of the members that are received in respective slots of the other. Moreover, in some embodiments, the first member and/or the second member may have symmetric features.

Accordingly, aligning the bolt and the bolt receiver may be selectable and adjustable for high convenience. The second member may also be strong and robustly secured within the first member once the second member has been positioned.

Also, the adjustable bolt receiver may have a relatively low part count for added manufacturing efficiency. The adjustable bolt receiver may be highly manufacturable and may be packaged neatly. The first member may nest within the second member and both members may be received, for example, within the sill; therefore, the bolt receiver may be compact, may have a low-profile, and may be aesthetically pleasing. Manufacture, assembly, and use may also be convenient and less time consuming.

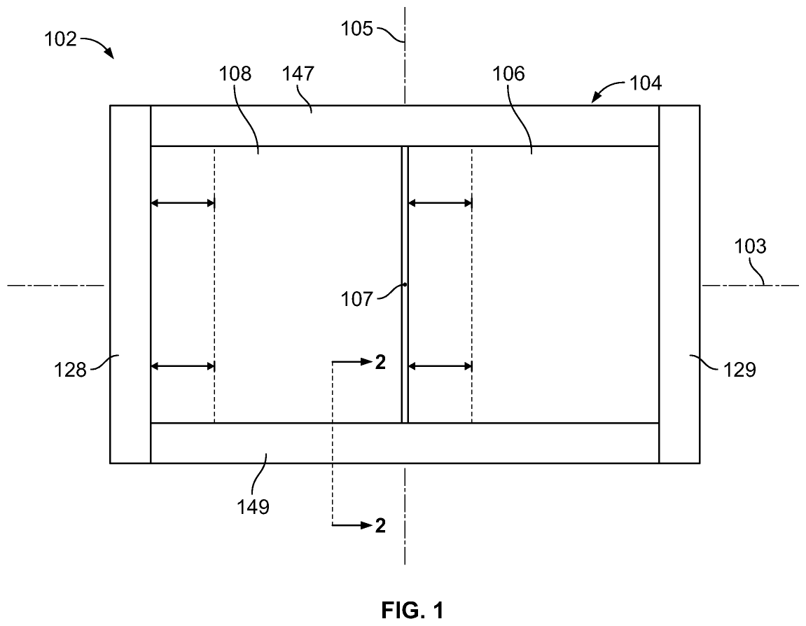

FIG. 1 illustrates a fenestration unit 102 according to example embodiments of the present disclosure. The fenestration unit 102 may be configured as a door unit in some embodiments. In some embodiments, the fenestration unit 102 may be configured as a slider door fenestration unit 102, such as with horizontally-sliding patio door unit for a building, dwelling, or other structure. However, it will be appreciated that features of the present disclosure may be included in hingedly-attached door panel system, a window fenestration unit or another fenestration unit without departing from the scope of the present disclosure.

The fenestration unit 102 may include a support structure, such as a rectangular frame 104 that defines a first axis 103, a second axis 105, and a third axis 107, which are orthogonal to each other. The first axis 103 may be a horizontal axis extending between a first jamb 128 and a second jamb 129 of the frame 104. The second axis 105 may be a vertical axis that is generally aligned with the direction of gravity and that extends between a header 147 and a sill 149 of the frame 104. The third axis 107 may be a horizontal axis extending in an interior-exterior direction through the frame 104.

The fenestration unit 102 may also include at least one panel, such as a first panel 106, and a second panel 108 that are supported by the frame 104. The panels 106, 108 may comprise door panels (i.e., door leafs) in some embodiments. In other embodiments, the panels 106, 108 may comprise window sashes. Furthermore, the panels 106, 108 may include and support glazing units (e.g., those with one or more panes of glass) in some embodiments.

One or both of the first and second panels 106, 108 may be moveably supported within the frame 104. In some embodiments, the first panel 106 may be fixed within the frame 104, and the second panel 108 may be supported for movement within the frame 104 between a closed position (shown in solid lines) and an open position (shown in phantom). In some embodiments, the first axis 103 defined by the frame 104 may be an axis for sliding the second panel 108 open and closed. The second panel 108 may be supported for sliding movement within the frame 104 along the first axis 103 as the second panel 108 moves within the frame 104 between the closed and open positions.

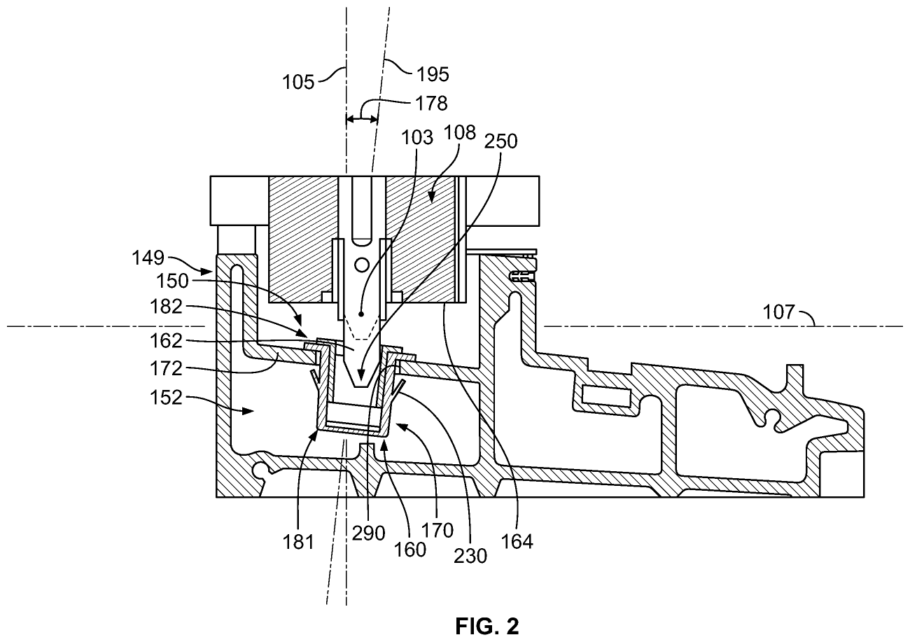

As shown in FIG. 2, the second panel 108 may be supported in a channel 150 of the sill 149, and the second panel 108 may be supported for sliding movement along the axis 103 therein (e.g., by one or more rollers, etc.). As such, the second panel 108 may slidingly move relative to the first panel 106 when moving between the closed and open positions. In some embodiments, the sill 149 may include a plurality of walls that define a hollow interior. For example, the sill 149 may include a sill cavity 152, which is spaced below the channel 150.

Additionally, the fenestration unit 102 may include a bolt securement system 160 for selectively securing the panel 108 to the frame 104. The bolt securement system 160 may include a bolt 162 (i.e., shank, etc.) that is included on the panel 108. The bolt 162 may be mounted to the panel 108 so as to move along a sliding axis that may be substantially parallel to the second axis 105 (i.e., upward and downward). The bolt 162 may be slidably attached to the panel 108 for movement between a retracted position (shown in phantom) and an extended position (shown in solid lines) relative to a bottom edge 164 of the panel 108. The bolt 162 may be operatively coupled to a knob, handle, or other selector device with which a user may selectively move the bolt 162 between the retracted and extended positions. Thus, the bolt 162 may be selectively moved relative to the sill 149 for securing the panel 108 to the sill 149; however, it will be appreciated that the bolt securement system 160 may be configured for securing the panel 108 to another member of the frame 104 without departing from the scope of the present disclosure.

The bolt securement system 160 may also include an adjustable bolt receiver 170, which is configured to receive the bolt 162 in the extended position. The bolt receiver 170 may be attached, supported, and mounted to the sill 149. For example, the bolt receiver 170 may be attached to and may extend through a top wall 172 of the sill 149 so as to extend partly into the sill cavity 152. The adjustable bolt receiver 170 may also include an opening 250 that defines a receiver axis 195. The receiver axis 195 may be disposed at an angle 178 relative to the sliding axis of the bolt (e.g., the second axis 105). However, when aligned along the sliding axis of the panel 108 (i.e., the first axis 103), there may be sufficient size tolerancing between the bolt 162 and the opening 250 to allow the bolt 162 to slide freely in and out of the opening 250.

The bolt 162 may be selectively extended into the bolt receiver 170 so as to provide interference against sliding movement of the panel 108 along the axis 103. The bolt 162 may be selectively retracted out of the bolt receiver 170 to thereby allow sliding movement of the panel 108 along the axis 103.

Furthermore, as will be discussed, the bolt receiver 170 may be adjustable between multiple positions so as to selectively position the opening 250 relative to the sill 149. Accordingly, the bolt receiver 170 may be selectively moved and adjusted for conveniently aligning with the bolt 162 (i.e., for conveniently aligning the receiver axis 195 and the sliding axis of the bolt 162 along the sliding axis of the panel 108).

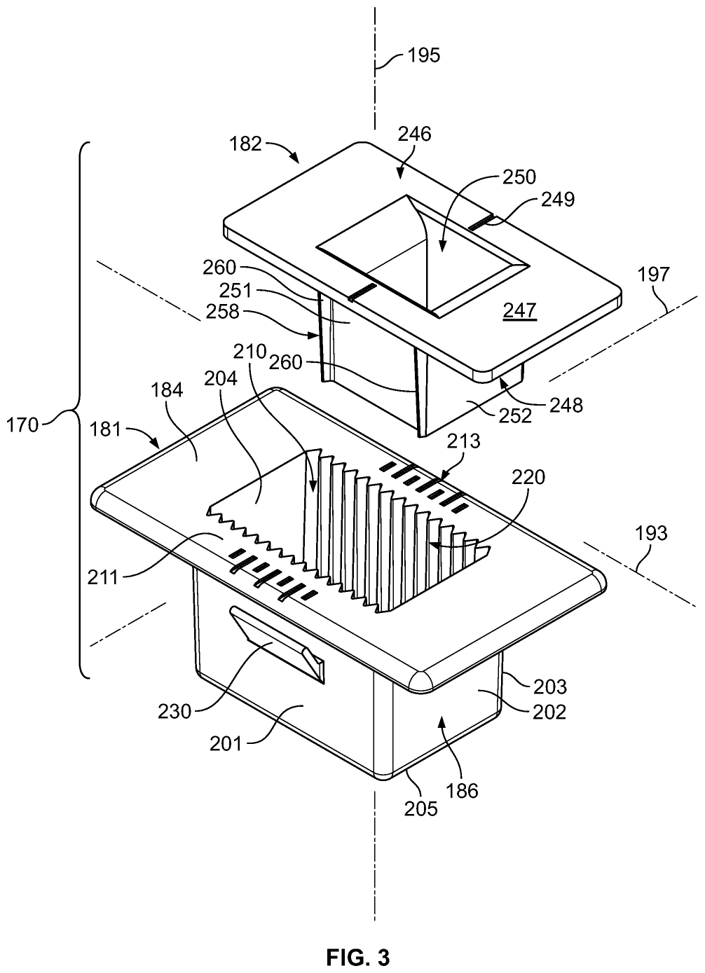

Referring now to FIG. 3, the adjustable bolt receiver 170 is shown in additional detail. As shown, the adjustable bolt receiver 170 may generally include a first member 181 (i.e., a retainer member) and a second member 182 (i.e., a receiver member) that are removably attached together. For reference purposes, a receiver Cartesian coordinate system is shown, which includes a first receiver axis 193, a second receiver axis 195, and a third receiver axis 197. As indicated in FIG. 2 and as will be discussed, the adjustable bolt receiver 170 may be attached to the sill 149 such that the first receiver axis 193 is aligned and parallel to the sliding axis of the panel 108 (i.e., aligned and parallel to the first axis 103); however, the bolt receiver 170 may be canted slightly, for example, at the angle 178 mentioned above.

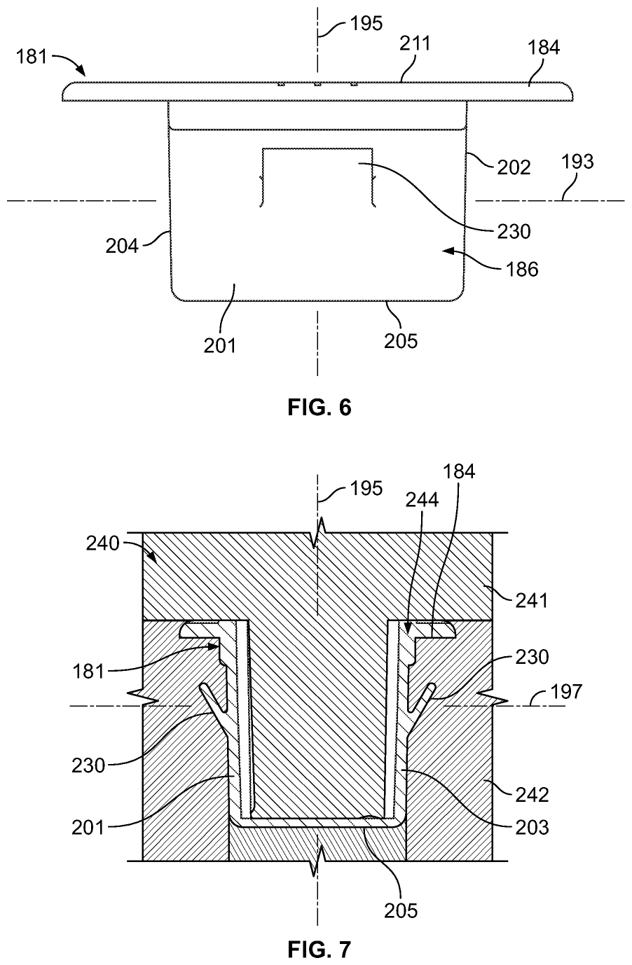

As shown in FIGS. 3, 5, 6, and 7, the first member 181 may be unitary, one-piece, monolithic part that is hollow and box-shaped. The first member 181 may be constructed of a rigid and strong polymeric material. In some embodiments, the first member 181 may be constructed of a material suitable for molding (e.g., injection molding). The first member 181 may include a support head 184 and a base extension 186. the support head 184 may comprise a flat plate that lies substantially within a plane defined by the first and third receiver axes 193, 197. The base extension 186 may be rectangular with a first wall 201, a second wall 202, a third wall 203, and a fourth wall 204 that extend along the second receiver axis 195 from the underside of the support head 184. The base extension 186 may also include a bottom wall 205 that is attached to the first, second, third, and fourth walls 201, 202, 203, 204 and that is substantially parallel to and spaced apart from the support head 184 along the second receiver axis 195. The first member 181 may further include a first opening 210. The first opening 210 may be a somewhat rectangular recess or blind hole that extends through the support head 184 and into the base extension 186. Thus, the first receiver axis 193 may extend between the second and fourth walls 202, 204, and the third receiver axis 197 may extend between the first and third walls 201, 203. The second receiver axis 195 may be the longitudinal axis (hole axis) of the first opening 210. The space between the second and fourth walls 202, 204 (along the first receiver axis 193) may be greater than the space between the first and third walls 201, 203 (along the third receiver axis 197); therefore, the first receiver axis 193 may be the major axis of the first opening 210, and the third receiver axis 197 may be the minor axis of the first opening 210.

Additionally, the first member 181 may further include a lip 211. The lip 211 may be defined by the upper surface of the support head 184 surrounding the first opening 210. The first member 181 may also include a first position indicator 213, such as a series of rule lines that are included on the lip 211 on both sides of the opening 210 and that are evenly spaced and arranged along the first receiver axis 193.

The first member 181 may also include one or more first engagement features 220 (FIGS. 3 and 5) for engaging and retaining the second member 182 in a fixed position. There may be a plurality of first engagement features 220. The first engagement features 220 may be configured to correspond and compliment the shape, dimension, etc. of similar engagement features of the second member 182. In some embodiments, the plurality of engagement features 220 may comprise an array of ridges 222 and respective slots 224 defined between neighboring pairs of ridges 222 (FIG. 5). The ridges 222 and slots 224 may be included within the first opening 210, on the interior surfaces of the first wall 201 and third wall 203, and the ridges 222 and slots 224 may extend longitudinally along the second receiver axis 195. In other words, an insertion axis of the slots 224 may extend parallel to the receiver axis 195. The first member 181 may include any suitable number of ridges 222 and slots 224 therebetween. For example, in some embodiments, there may be fourteen ridges 222 on the first wall 201 and fourteen corresponding ridges 222 on the third wall 203. Conversely there may be fifteen slots 224 on the first wall 201 and fifteen corresponding slots 224 on the third wall 203. The slots 224 and ridges 222 may be aligned across the first receiver axis 193. The ridges 222 may have a tapered cross section (i.e., may be individually tapered in a cross-section taken normal to the second receiver axis 195 as shown in FIG. 5) so as to taper down to a point on the interior ends of the ridges 222. The slots 224 may be tapered inversely as compared to the ridges 222. Thus, the slots 224 may taper down to a point within the slots 224. Accordingly, the first engagement features 220 may have a sawtooth-shaped cross-sectional profile (FIG. 5). In some embodiments, a majority (e.g., substantially all) of the first wall 201 and the third wall 203 may be ribbed with the first engagement features 220. The remainder of the first opening 210 may be defined by the substantially flat interior surfaces of the second wall 202 and the fourth wall 204.

Furthermore, the first member 181 may include at least one snap-fit projection 230. In some embodiments, there may be two snap-fit projections 230, and one may project from the first wall 201 and the other may project from the third wall 203 (FIG. 7). The snap-fit projections 230 may be resiliently flexible. In a neutral, unbiased position, one of the projections 230 may be a flat, rectangular flap that projects outward to be cantilevered from the first wall 201 along the third receiver axis 197 and upward toward the underside of the support head 184. The other projection 230 may be similar, except that it may project outward from the third wall 203 and upward toward the underside of the support head 184. The projections 230 may resiliently bend or otherwise deflect toward the first wall 201 and third wall 203, respectively, and may resiliently recover toward the neutral position represented in FIG. 3. Accordingly, the first member 181 may be conveniently snap-fit into the sill 149 in some embodiments as will be discussed in greater detail below.

In some embodiments, the first member 181 may be symmetric with respect to at least one line of symmetry. For example, the first member 181 may be symmetric about the first receiver axis 193. As will be appreciated, this symmetry may make installation convenient because the first member 181 may be robustly attached to the sill 149 in multiple orientations.

Moreover, as shown in FIG. 7, the first member 181 may be formed in a molding device 240. The molding device 240 may include a first mold member 241 and a second molding member 242 that may be fit together to define a mold cavity 244 (e.g., injection molding). Material (e.g., polymeric material) may be provided in the mold cavity 244, and the mold members 241, 242 may shape and form the first member 181 according to the interior surfaces of the mold cavity 244. Accordingly, the first member 181 may be formed efficiently in the molding device 240.

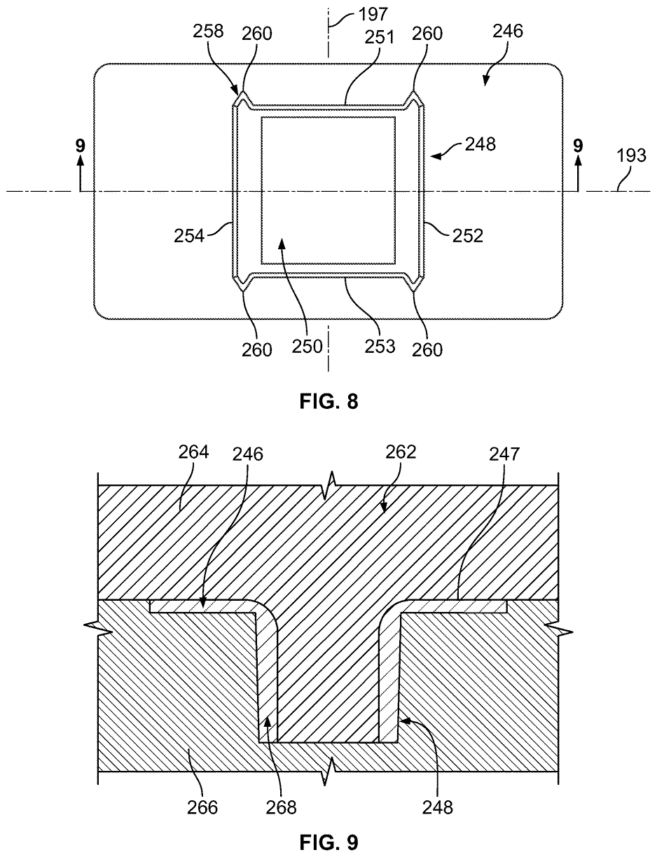

Referring now to FIGS. 3, 8, and 9, the second member 182 may be a unitary, one-piece, monolithic part. The second member 182 may be constructed of a rigid and strong polymeric material. In some embodiments, the second member 182 may be constructed of a material suitable for molding (e.g., for injection molding). The second member 182 may include a strike head 246 and an insert projection 248 that projects from the strike head 246 along the second receiver axis 195.

The strike head 246 may comprise a flat plate that lies substantially within a plane defined by the first and third receiver axes 193, 197. The strike head 246 may include an upper strike surface 247 that faces upward along the second receiver axis 195. In some embodiments, the upper strike surface 247 may include a second position indicator 249, such as one or more rule lines that are centered on the surface 247 along the first receiver axis 193.

The insert projection 248 may be hollow and tubular and may include a first wall 251, a second wall 252, a third wall 253, and a fourth wall 254 that extend along the second receiver axis 195 from the underside of the strike head 246. The second member 182 may further include the second opening 250 mentioned above in reference to FIG. 2. In some embodiments, there may be a large-radius, convex transition between the upper strike surface 247 and the interior side of the second wall 252, and a similar transition between the upper strike surface 247 and the interior side of the fourth wall 254.

The second opening 250 may be a through-hole that extends through the strike head 246 and that is defined between the walls 251, 252, 253, 254 of the insert projection 248. The second opening 250 may be rectangular (e.g., substantially square) in a cross-section taken normal to the second receiver axis 195. The first receiver axis 193 may extend between the second and fourth walls 252, 254, and the third receiver axis 197 may extend between the first and third walls 251, 253.

The second member 182 may also include at least one second engagement feature 258 for engaging with the first member 181 in a plurality of different fixed positions. The second engagement feature 258 may correspond in shape, position, etc. to the first engagement features 220 of the first member 181 for selectively engaging therewith. In some embodiments, the second engagement feature 258 may include one or more flanges 260 extending from the insert projection 248. Specifically, there may be four flanges 260 (i.e., a first, second, third, and fourth flange 260) that extend outwardly from the respective corners of the insert projection 248 along the third receiver axis 197. The flanges 260 may be tapered and may taper down to a point as the flanges 260 extend along the third receiver axis 197. The flanges 260 may be aligned across the first receiver axis 193.

In some embodiments, the second member 182 may be symmetric with respect to at least one line of symmetry. For example, the second member 182 may be symmetric about the first receiver axis 193. As will be appreciated, this symmetry may make installation convenient because the second member 182 may be robustly attached to the first member 181 in multiple orientations.

Moreover, as shown in FIG. 9, the second member 182 may be formed in a molding device 262. The molding device 262 may include a first mold member 264 and a second molding member 266 that may be fit together to define a mold cavity 268 (e.g., for injection molding). Material (e.g., polymeric material) may be provided in the mold cavity 268, and the mold members 264, 266 may shape and form the second member 182 according to the interior surfaces of the mold cavity 268. Accordingly, the second member 182 may be formed efficiently in the molding device 262.

Referring now to FIGS. 2-4, installation and use of the adjustable bolt receiver 170 and the bolt securement system 160 will be discussed according to example embodiments. The bolt 162 may be slidably mounted (e.g., with fasteners) to the panel 108 and selectively moved to the retracted position (shown in phantom in FIG. 2). Then, the first member 181 may be attached to the sill 149. For example, the sill aperture 290 may be formed (e.g., by drilling) into the top wall 172. The sill aperture 290 may be positioned into rough alignment with the bolt 162.

Then, the first member 181 may be manually pushed into a sill aperture 290 in the top wall 172. The sill aperture 290 may be slightly larger than the periphery of the base extension 186, and as the first member 181 is advanced along the second receiver axis 195, the snap-fit projections 230 may resiliently bend inward to clear the rim of the sill aperture 290. Once the snap-fit projections 230 have advanced beyond the sill aperture 290 and into the sill cavity 152, the projections 230 may resiliently recover, thereby securing the first member 181 to the sill 149.

Next, a position for the second member 182 within the first member 181 may be determined and selected. More specifically, the user may move the panel 108 to a desired position within the frame 104 (e.g., to a closed position), and the bolt 162 may be moved to its extended position (shown in solid lines in FIG. 2) and into the first opening 210. Accordingly, the user may use the first position indicator 213 to visually confirm where the sliding axis of the bolt 162 (axis 105) is located along the first receiver axis 193. With this information, the user may manually insert (e.g., push) the insert projection 248 into the first opening 210 until the strike head 246 overlaps and abuts the lip 211 of the support head 184. The flanges 260 of the second member 182 may be snugly fit, may nest, or may otherwise be received in respective ones of the slots 224 of the first member 181. As such, the second member 182 may be robustly retained in a fixed position along the first receiver axis 193 due to interference between the flanges 260 and the ridges 222. If properly positioned, the second position indicator 249 will align with the line of the first position indicator 213 that was previously identified as being aligned with the bolt 162. As such, the second opening 250 may be conveniently positioned and aligned along the first receiver axis 193 with the bolt 162.

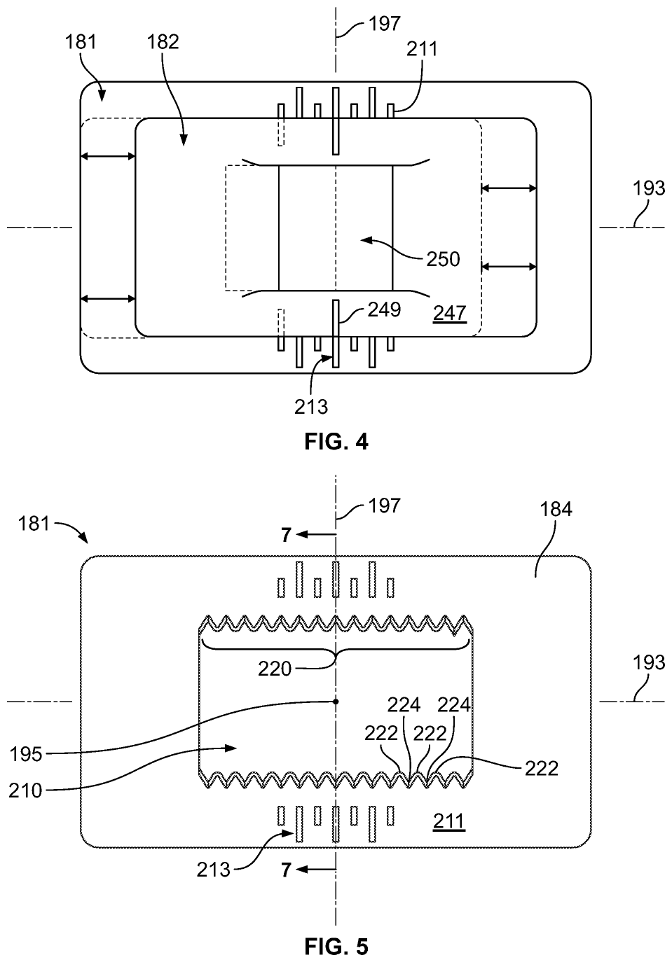

If further adjustment is needed, then the second member 182 may be manually pulled and removed from the first member 181, and the second member 182 may be re-inserted at the adjusted position along the first receiver axis 193 with the flanges 260 fitting with other ones of the slots 224 of the first member 181. FIG. 4 illustrates two of a plurality of potential positions of the second member 182 within the first member 181. Specifically, a first, centered position of the second member 182 is shown in solid lines, and a second position of the second member 182 is shown in phantom. It will be appreciated that the second member 182 may be fit into additional positions within the first member 181 as well. In some embodiments, the adjustable bolt receiver 170 may allow for up to ⅜ inches of adjustment (i.e., 0.375 inches or 9.5 mm of adjustment) relative to the first member 181 along the first receiver axis 193.

Thus, the adjustable bolt receiver 170 may make alignment of the bolt and the bolt receiver to be highly convenient and less time consuming. The receiver 170 may be strong and robust for securing the panel 108 to the frame 104. Also, the adjustable bolt receiver 170 may have a relatively low part count for added manufacturing efficiency, reduction of costs, ease of assembly, etc. The adjustable bolt receiver 170 may be assembled and robustly retained without the need for fasteners (i.e., a fastener-less assembly). The adjustable bolt receiver 170 may be highly manufacturable and may be packaged neatly. Moreover, the bolt receiver 170 may also be compact, may have a low-profile, and may be aesthetically pleasing.

Additional example embodiments of the present disclosure may include an adjustable bolt receiver for selectively securing a panel of a fenestration unit to a panel support of the fenestration unit is disclosed wherein the fenestration unit has a bolt that is slidably attached to the panel for movement between a retracted position and an extended position relative to the panel for selectively engaging with the panel support. The adjustable bolt receiver includes a first member configured to be fixedly attached to the panel support, and the first member has a first opening defining an axis. The first member includes at least one first engagement feature. Moreover, the adjustable bolt receiver includes a second member that includes a strike head and an insert projection that projects from the strike head. The insert projection is receivable in the first opening in a first position along the axis and, alternatively, in a second position along the axis. The second member includes at least one second engagement feature configured to engage with the at least one first engagement feature for retaining the insert projection in the first position and in the second position along the axis. The insert projection at least partly defines a second opening configured to receive the bolt when in the extended position to secure the panel to the panel support.

In some embodiments, the second opening is a through-hole extending along an insertion axis through the strike head and the insert projection.

Also, in some embodiments, the second opening is a rectangular through-hole.

In some embodiments, the first member includes a lip, and the strike head overlaps the lip in the first position and in the second position.

In some embodiments, the lip includes a first position indicator and the strike head includes a second position indicator that aligns with the first position indicator.

Moreover, in some embodiments the first member is symmetrical about the axis.

Furthermore, in some embodiments, the second member is symmetrical about the axis.

In some embodiments, both the first member and the second member are symmetrical about the axis.

Also, in some embodiments, the at least one first engagement feature comprises an array of slots, and the at least one second engagement feature includes at least one flange extending from the insert projection.

In some embodiments, the at least one flange includes a first flange and a second flange disposed on opposite sides of the axis.

Additionally, in some embodiments, individual ones of slots in the array of slots may extend longitudinally along an insertion axis and may be individually tapered in a cross-section taken normal to the insertion axis. The at least one flange is tapered in the cross-section.

Moreover, in some embodiments, the first member includes a support head and a base extension that extends from the support head. The base extension includes the first opening, the base extension includes the plurality of first engagement features, and the base extension is insertable into the panel support.

In some embodiments, the base extension includes a snap-fit projection that is resiliently flexible for snap-fitting into the panel support.

In some embodiments, the first member and the second member are constructed of a polymeric material.

Also, in another embodiment, a method of manufacturing an adjustable bolt receiver configured for selectively securing a panel of a fenestration unit to a panel support of the fenestration unit is disclosed, wherein the fenestration unit has a bolt that is slidably attached to the panel for movement between a retracted position and an extended position relative to the panel for selectively engaging with the panel support. The method includes providing a first member configured to be fixedly attached to the panel support, and the first member has a first opening defining an axis. The first member includes at least one first engagement feature. Furthermore, the method includes providing a second member that includes a strike head and an insert projection that projects from the strike head. The second member includes at least one second engagement feature, and the insert projection at least partly defining a second opening configured to receive the bolt when in the extended position to secure the panel to the panel support. The method also includes selecting one of a first position for the insert projection in the first opening along the axis and a second position for the insert projection in the second opening along the axis. Additionally, the method includes inserting the insert projection in the selected one of the first position and the second position. The at least one second engagement feature is configured to engage with the at least one first engagement feature for retaining the insert projection in the first position and, alternatively, in the second position along the axis.

In some embodiments, the method includes providing the first member includes molding the first member.

Also, in some embodiments, the method includes providing the second member includes molding the second member.

Additionally, in a further embodiment, a fenestration unit is disclosed that includes a panel with a bolt that is slidably attached thereto for movement between a retracted position an extended position relative to the panel. The fenestration unit includes a frame that supports the panel for sliding movement within the frame along an axis, and the frame includes a sill. Moreover, the fenestration unit includes an adjustable bolt receiver that includes a first member configured to be fixedly attached to the sill, and the first member has a first opening that extends along the axis. The first member includes at least one array of ridges and slots. Also, the adjustable bolt receiver includes a second member that includes a strike head and an insert projection that projects from the strike head. The insert projection is receivable in the first opening in a first position along the axis and, alternatively, in a second position along the axis. The second member includes at least one flange that is removably engaged within one of the slots of the array in the first position and in another of the slots of the array in the second position. The insert projection at least partly defines a second opening configured to receive the bolt when in the extended position to secure the panel to the panel support.

In some embodiments, the first member and the second member are symmetrical about the axis.

Also, in some embodiments, the first member includes a snap-fit projection that is resiliently flexible for snap-fitting into the sill.

It is intended that subject matter disclosed in particular portions herein can be combined with the subject matter of one or more of other portions herein as long as such combinations are not mutually exclusive or inoperable. In addition, many variations, enhancements and modifications are possible.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It is understood that various changes may be made in the function and arrangement of elements described in an exemplary embodiment without departing from the scope of the disclosure as set forth in the appended claims.

What is claimed is:

1. An adjustable bolt receiver for selectively securing a panel of a fenestration unit to a panel support of the fenestration unit, the fenestration unit having a bolt that is slidably attached to the panel for movement between a retracted position and an extended position relative to the panel for selectively engaging with the panel support, the adjustable bolt receiver comprising:
a first member configured to be fixedly attached to the panel support, the first member having a first opening defining an axis, the first member including at least one first engagement feature; and
a second member that includes a strike head and an insert projection that projects from the strike head, the insert projection being receivable in the first opening in a first position along the axis and, alternatively, in a second position along the axis, the second member including at least one second engagement feature configured to engage with the at least one first engagement feature for retaining the insert projection in the first position and in the second position along the axis, the insert projection at least partly defining a second opening configured to receive the bolt when in the extended position to secure the panel to the panel support.

2. The adjustable bolt receiver of claim 1, wherein the second opening is a through-hole extending along an insertion axis through the strike head and the insert projection.

3. The adjustable bolt receiver of claim 2, wherein the second opening is a rectangular through-hole.

4. The adjustable bolt receiver of claim 1, wherein the first member includes a lip, wherein the strike head overlaps the lip in the first position and in the second position.

5. The adjustable bolt receiver of claim 4, wherein the lip includes a first position indicator and the strike head includes a second position indicator that aligns with the first position indicator.

6. The adjustable bolt receiver of claim 1, wherein the first member is symmetrical about the axis.

7. The adjustable bolt receiver of claim 1, wherein the second member is symmetrical about the axis.

8. The adjustable bolt receiver of claim 1, wherein both the first member and the second member are symmetrical about the axis.

9. The adjustable bolt receiver of claim 1, wherein the at least one first engagement feature comprises an array of slots, and wherein the at least one second engagement feature includes at least one flange extending from the insert projection.

10. The adjustable bolt receiver of claim 9, wherein the at least one flange includes a first flange and a second flange disposed on opposite sides of the axis.

11. The adjustable bolt receiver of claim 9, wherein individual ones of slots in the array of slots extend longitudinally along an insertion axis and are individually tapered in a cross-section taken normal to the insertion axis; and
wherein the at least one flange is tapered in the cross-section.

12. The adjustable bolt receiver of claim 1, wherein the first member includes a support head and a base extension that extends from the support head, the base extension including the first opening, the base extension including the plurality of first engagement features, the base extension being insertable into the panel support.

13. The adjustable bolt receiver of claim 12, wherein the base extension includes a snap-fit projection that is resiliently flexible for snap-fitting into the panel support.

14. The adjustable bolt receiver of claim 1, wherein the first member and the second member are constructed of a polymeric material.

15. A method of manufacturing an adjustable bolt receiver configured for selectively securing a panel of a fenestration unit to a panel support of the fenestration unit, the fenestration unit having a bolt that is slidably attached to the panel for movement between a retracted position and an extended position relative to the panel for selectively engaging with the panel support, the method comprising:
providing a first member configured to be fixedly attached to the panel support, the first member having a first opening defining an axis, the first member including at least one first engagement feature;
providing a second member that includes a strike head and an insert projection that projects from the strike head, the second member including at least one second engagement feature, the insert projection at least partly defining a second opening configured to receive the bolt when in the extended position to secure the panel to the panel support;
selecting one of a first position for the insert projection in the first opening along the axis and a second position for the insert projection in the second opening along the axis; and
inserting the insert projection in the selected one of the first position and the second position, the at least one second engagement feature configured to engage with the at least one first engagement feature for retaining the insert projection in the first position and, alternatively, in the second position along the axis.

16. The method of claim 15, wherein providing the first member includes molding the first member.

17. The method of claim 15, wherein providing the second member includes molding the second member.

18. A fenestration unit comprising:
a panel with a bolt that is slidably attached thereto for movement between a retracted position an extended position relative to the panel;
a frame that supports the panel for sliding movement within the frame along an axis, the frame including a sill; and
an adjustable bolt receiver that includes:
a first member configured to be fixedly attached to the sill, the first member having a first opening that extends along the axis, the first member including at least one array of ridges and slots; and
a second member that includes a strike head and an insert projection that projects from the strike head, the insert projection being receivable in the first opening in a first position along the axis and, alternatively, in a second position along the axis, the second member including at least one flange that is removably engaged within one of the slots of the array in the first position and in another of the slots of the array in the second position, the insert projection at least partly defining a second opening configured to receive the bolt when in the extended position to secure the panel to the panel support.

19. The fenestration unit of claim 18, wherein the first member and the second member are symmetrical about the axis.

20. The fenestration unit of claim 18, wherein the first member includes a snap-fit projection that is resiliently flexible for snap-fitting into the sill.
